(19) United States
(12) Patent Application Publication
(10) Pub. No.: US 2023/0021467 A1
(43) Pub. Date: Jan. 26, 2023

(54) Model-Based System Architecture Design Method for Unmanned Aerial Vehicle (UAV) Systems

(71) Applicant: Beihang University, Beijing (CN)

(72) Inventors: Xinghai Gao, Beijing (CN); Yuanjie Lu, Beijing (CN); Chuangye Chang, Beijing (CN); Zeshi Liu, Beijing (CN); Zhuoqi Wang, Beijing (CN); Jun Ge, Beijing (CN); Lingfei You, Beijing (CN)

(21) Appl. No.: 17/867,829

(22) Filed: Jul. 19, 2022

(30) Foreign Application Priority Data
Jul. 21, 2021 (CN) 202110825945.7

(51) Int. Cl. B64F 5/00; G06F 30/15; B64C 39/02

(52) U.S. Cl. CPC B64F 5/00; B64C 39/024; G06F 30/15; G06F 2111/10

(57) ABSTRACT

The present disclosure discloses a model-based architecture design method for an unmanned aerial vehicle (UAV) system, which aims to deal with challenges of changeable operational requirements, shortened design period, and decreased technical risks in a current UAS design process. A data-driven architecture development method is used. By establishing an architecture development framework of the UAS, a framework modeling process oriented to different viewpoints is designed, and modeling and simulation specifications based on SysML and Modelica are defined, such that design of the UAS starts from conception and confirmation of an operational concept. The method focuses on forward analysis and design of a system framework, and concept verification and metric closed-loop are carried out at an early stage of the design of the UAS by virtue of logic modeling and system simulation.

### CROSS REFERENCE TO RELATED APPLICATION

This patent application claims the benefit and priority of Chinese Patent Application No. 202110825945.7, filed on Jul. 21, 2021, the disclosure of which is incorporated by reference herein in its entirety as part of the present application.

### TECHNICAL FIELD

The present disclosure belongs to the field of unmanned aerial vehicle system (UAS) design, and relates to a model-based architecture design method for the UAS, which is a model-based method for UAS operational requirement capture, functional behavior analysis, and architecture comprehensive trade-off

### BACKGROUND ART

With the advancement of communication, control, and artificial intelligence, the UAS plays an increasingly important role in the civilian and military fields. Especially in the defense field, the operational concepts of the UAS featuring cross-domain interoperability, manned aerial vehicle/ unmanned aerial vehicle (UAV) formations, and UAV swarms are emerging. All these have brought challenges to the traditional design paradigm of the carrier-centric UAS, and it is urgent to establish a forward design process for the UAS with operational requirements as driver and the system architecture as the core.

Since the inception of the Zachman architecture framework, architectural methods have gradually become an effective way to solve complex problems. In particular, the DoDAF architecture framework released by the U.S. Department of Defense has become an effective tool for complex system planning, management, design, construction, and application. However, the meta-model as well as 8 viewpoints and 52 views contained in the DoDAF architecture framework are too complicated for the design of the UAS. It is urgent to define the architecture development framework and development method of the UAS to support the architecture design of the UAS.

The system modeling language SysML, as a general architecture description language, supports formal modeling of the requirements, structures, behaviors, and parameters of complex systems. However, due to the versatility, the SysML brings flexibility and semantic ambiguity to the architecture modeling of the UAS. It is urgent to establish a semantic-based logical mapping relationship between SysML and the architecture development framework of the UAS, which brings specification and rigor to the architecture modeling of the UAS while ensuring flexibility.

SysML is a formal system architecture description language, but it does not have the ability of mathematical analysis. As an object-oriented multi-disciplinary unified modeling language, Modelica has causal/non-causal and discrete/continuous mathematical solution capabilities, which can effectively undertake the architectural model of SysML and make up for its weaknesses in mathematical analysis. Although there is already a transformation standard from SysML to Modelica, it is only a general mapping specification based on syntax, which cannot support transformation from the architecture description model of the UAS to the analysis model from the semantic aspect. It is urgent to carry out semantic transformation and integration of the SysML-based logical model and the Modelica-based mathematical model of the UAS.

### SUMMARY

In view of the above problems, the present disclosure provides a model-based architecture design method for a UAS, including providing an architecture development framework of the UAS, designing an architecture development process of the UAS, defining modeling and simulation specifications of the UAS architecture, and providing a transformation and integration path of an operational spatio-temporal model, a SysML logical model, and a Modelica mathematical model of the UAS.

The model-based architecture design method for a UAS provided by the present disclosure includes the following specific steps:
step 1: establishing an architecture development framework for the UAS, including: defining viewpoints of concern in a UAS architecture design process and views to be developed in each viewpoint;
step 2: designing a development process of the UAS from an operational viewpoint, developing a logical model and spatio-temporal model of UAS operation according to an input UAS operational concept, carrying out simulation of a system of systems model, verifying rationality of the system of systems model, and generating operational requirements;
step 3: designing a development process of the UAS from a logical viewpoint, developing a logical model and geometric model of the UAS itself according to input UAS operational requirements, carrying out simulation of a system model, verifying rationality of the system model, and generating system requirements;
step 4: designing a development process of the UAS from a physical viewpoint, developing a logical model and mathematical model in physics of components (lower-level system elements) of the UAS according to input UAS requirements, carrying out simulation of a component model, verifying rationality of the component model, and generating component requirements; and
step 5: carrying out integration of cross-level spatio-temporal models, logical models, and mathematical models from the operational viewpoint, the logical viewpoint, and the physical viewpoint, so as to realize multi-domain, multi-dimensional, and multi-disciplinary UAS architecture simulation, and carry out closed-loop verification of the operational requirements, the system requirements, and the component requirements of the UAS.

The present disclosure has the following advantages:
1. The model-based architecture design method for a UAS provided by the present disclosure provides the architecture development framework of the UAS, containing all the elements of the UAS architecture design such as “operational tasks-operational activities-operational requirements - system requirements - system architecture-measurement metrics” to meet requirements of forward design of the UAS.
2. The model-based architecture design method for a UAS provided by the present disclosure designs a modeling process from the operational viewpoint, the logical viewpoint, and the physical viewpoint based on the architecture development framework of the UAS. The creation point organically integrates SysML and Modelica modeling languages with modeling process, such that UAS designers can quickly carry out UAS architecture design.
3. The model-based architecture design method for a UAS provided by the present disclosure builds an operational concept-oriented UAS architecture modeling and simulation environment. The creation point integrates the spatio-temporal model, the logical model, and the mathematical model through a finite state machine, and realizes joint analysis and simulation of “spatio-temporal, logic and mathematical” heterogeneous models through an event-driven mechanism.

### BRIEF DESCRIPTION OF THE DRAWINGS

FIG. 1 shows a model-based architecture design method for a UAS;

FIG. 2 is a diagram of a development process of the UAS from an operational viewpoint,

FIG. 3 is a diagram of a development process of the UAS from a logical viewpoint;

FIG. 4 is a diagram of a development process of the UAS from a physical viewpoint;

FIG. 5 is a schematic diagram of integration of spatio-temporal, logic and mathematical models;

FIGS. 6A-6D together form an example diagram of model development of the UAS from the operational viewpoint,

FIGS. 7A-7C together form an example diagram of model development of the UAS from the logical viewpoint; and

FIGS. 8A-8D together form a diagram of a development process of the UAS from the physical viewpoint.

### DETAILED DESCRIPTION OF THE EMBODIMENTS

The implementation steps of the present disclosure will be further described below in detail.

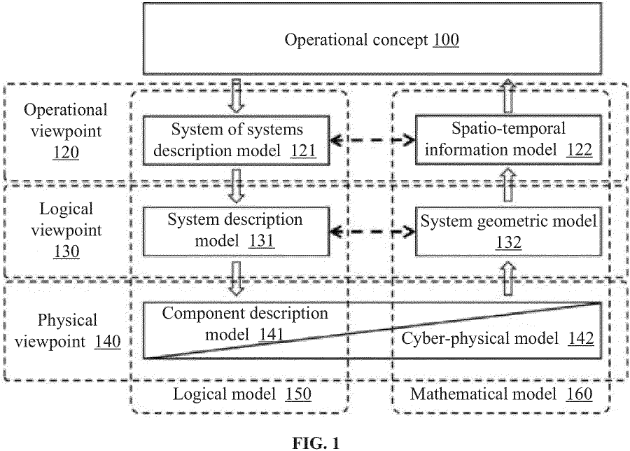

The model-based architecture design method for a UAS provided by the present disclosure is shown in FIG. 1, and a specific design process is as follows.

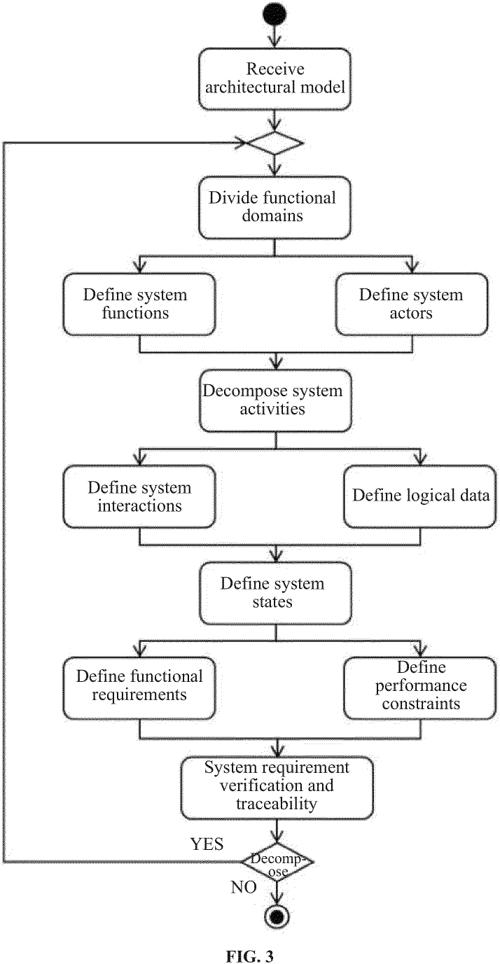

Step 1: An architecture development framework of the UAS is established, including: defining viewpoints of concern in a UAS architecture design process and views to be developed in each viewpoint. As shown in FIGS. 1, 3 viewpoints and 26 views are defined. The 3 viewpoints include an operational viewpoint, a logical viewpoint, and a physical viewpoint. The operational viewpoint and the logical viewpoint are divided into 5 categories and 22 views according to requirements, structures, behaviors, constraints, data, and simulation, and the physical viewpoint is divided into 3 categories and 4 views according to product, data, and simulation. Requirement, structure, behavior, constraint, and data-type models in the operational and logical viewpoints, and product and data-type models in the physical viewpoint belong to logical models. Simulation models in the three viewpoints belong to mathematical models. Due to temporal and spatial characteristics, the spatio-temporal information model and the system geometric model are subsumed to spatio-temporal models. In this way, the 26 view models are divided into three categories: the spatio-temporal model, the logical model, and the mathematical model (especially the cyber-physical model).

Table 1

Architecture development framework of UAS

| | Requirement | Structure | Behavior | Constraint | Data | Simulation |
|---|---|---|---|---|---|---|
| Operational Viewpoint | 1. Operational requirements 2. Operational requirement traceability | 1. Operational nodes 2. Operational interactions 3. Operational actors | 1. Operational use cases 2. Operational activities 3. Operational states | 1. Measure of effectiveness (MOE) | 1. Conceptual data | 1. Spatio-temporal information model |
| | Requirement | Structure | Behavior | Constraint | Data | Simulation |
| Logical Viewpoint | 1. System requirements 2. System requirement traceability | 1. System composition 2. System interactions 3. Sector actors | 1. System use cases 2. System activities 3. Sector states | 1. Measure of performance (MOP) | 1. Logical data | 1. System geometric model |
| | Product | | | | Data | Simulation |
| Physical Viewpoint | 1. Physical specifications (size, weight, power consumption, etc.) 2. Physical interfaces (mechanical, electrical, information, etc.) | | | | 1. Physical data | 1. Cyber-physical model |

The architecture development framework of the UAS is the basic framework of the present disclosure, and the development of the system of systems model, system model, and component model in the subsequent steps is carried out based on this framework.

The following is a description of the viewpoints of concern in the UAS architecture design process, and the views to be developed in each viewpoint.

### 1. Operational Viewpoint (120)

From the viewpoint of operational personnel, an system of systems description model (121) (including structural information such as operational nodes, interactions, and actors, behavioral information such as operational tasks, activities, and states, conceptual data such as exchanged materials, energy (771), and information, and constraint information on operational effectiveness), and a spatio-temporal information model (122) of the operational concept are established based on the operational concept (100). The views contained in the operational viewpoint are defined as follows.

101. Operational requirements: requirements for operational tasks meeting enterprise strategies or responding to external threats, as well as related operational nodes, operational activities, and effectiveness constraints.

102. Operational requirement traceability: a traceability relationship between operational requirements and model elements such as operational tasks, operational nodes, operational interactions, operational activities, operational states, conceptual data, and effectiveness constraints is established.

103. Operational nodes: through analysis of operational requirements, various entities involved in operational activities, including organizations, processes, equipment, and personnel, are extracted.

104. Operational interactions: based on decomposition of operational activities, the resource interaction between operational nodes is analyzed, and the operational ports between operational nodes and the materials, energy, and information transferred by the operational ports are defined.

105. Operational actors: an abstract expression of various roles participating in operational tasks. Actors can be organizations, processes, personnel, equipment, and even natural and induced environments.

106. Operational tasks: operational objectives that must be achieved in order to meet operational requirements from the viewpoint of operation. The operational tasks are conducted by operational actors.

107. Operational activities: expressing the logic of the activities implemented by each operational task, as well as the related control flow and object flow. These activities will be assigned to the corresponding operational nodes and actors.

108. Operational states: expressing state transition of various operational elements during operational, including state transition of each operational node and participant.

109. Conceptual data: expressing materials, energy, and information exchanged between operational nodes during operational, which is referenced during operational interactions and the definition of operational activities.

110. Effectiveness constraints: expressing the constraint relationship between the MOE of the operational task and the key performance parameter (KPP) of different operational nodes and actors.

111. Spatio-temporal information models: the spatio-temporal deduction process of the UAS operational concept is expressed in a three-dimensional visualization manner.

### 2. Logical Viewpoint (130)

The logical viewpoint undertakes the model product from the operational viewpoint, and a system description model (131) of elements such as carrier, payload, communication, and control in the UAS (containing structural information such as composition, interactions, and actors of the system, behavioral information such as functions, activities and states of the system, logical data such as exchanged materials, energy, and information, and constraint information on system performance) and a system geometric model (132) are established. The views contained in the logical viewpoint are defined as follows.

201. System requirements: technical requirements for the structures, behaviors, constraints, and data of elements such as the carrier, payload, communication, and control of the UAS.

202. System requirement traceability: a traceability relationship between requirements of the UAS and model elements such as system functions, system composition, system interactions, system activities, system states, logical data, and performance constraints of the UAS.

203. System composition: a hierarchical relationship of elements such as carrier, payload, communication, and control contained in the UAS is described to form a decomposition structure of the UAS.

204. System interactions: based on decomposition of the system activities, the resource interaction of elements of the UAS is analyzed, and the logical ports for interaction of elements of the UAS and the materials, energy, and information transferred on the logical ports are defined.

205. System actors: various roles that interact with elements such as carrier, payload, communication, and control. Actors can be organizations, personnel, equipment, and even natural and induced environments.

206. System functions: visible and valuable services provided by the UAS to the user (such as flight control and reconnaissance). The system functions are conducted by the system actors.

207. System activities: logics of the activities implemented by the system functions, as well as the related control flow and object flow. These activities will be assigned to the corresponding elements such as carrier, payload, communication, and control.

208. System states: expressing state transition of the UAS during operation, including state transition of the carrier, payload, communication, control, and system actors.

209. Logical data: expressing materials, energy, and information exchanged between elements such as carrier, payload, communication, and control, which is referenced during system interactions and the definition of system activities. Logical data is a further refinement of conceptual data, but does not involve specific implementation details.

210. Performance constraints: expressing the constraint relationship between the MOP of the UAS and the MOP of elements such as carrier, payload, communication, and control.

211. System geometric models: three-dimensional geometric information of elements such as carrier, payload, communication, and control is expressed in a visualization manner, and discrete and continuous behaviors of the UAS can be integrated.

### 3. Physical Viewpoint (140)

The physical viewpoint undertakes the model product from the logical viewpoint. The physical implementation of elements such as carrier, payload, communication, and control is designed. A cyber-physical model (142) of the system is established. Bottom-up virtual integration and co-simulation is carried out. The achievability of MOPs assigned to elements such as carrier, payload, communication, and control and the achievability of the MOP of the system are verified, and a component description model (141) for system elements (including physical specifications, physical interfaces, physical data of the components) is generated based on the verified design parameters. The views contained in the physical viewpoint are defined as follows.

301. Physical specifications: expressing physical specifications of elements such as the carrier, payload, communication, and control, including information such as size, weight, and power consumption.

302. Physical interfaces: expressing physical connection between elements such as carrier, payload, communication, and control, including mechanical, electrical, and information types. The physical interface is an instantiation of a logical port.

303. Physical data: expressing physical formats of materials, energy, and information transferred by the interface of elements such as carrier, payload, communication, and control, which is related to the specific implementation.

304, Cyber-physical models: expressing a mathematical model (160) of elements such as carrier, payload, communication, and control in terms of mechanics, electricity, hydraulic pressure, and control.

Step 2: A development process of the UAS from an operational viewpoint is designed. A logical model (150) and spatio-temporal model of UAS operation are developed according to an input UAS operational concept. Simulation of a system of systems model is carried out. Rationality of the system of systems model is verified. Operational requirements are generated.

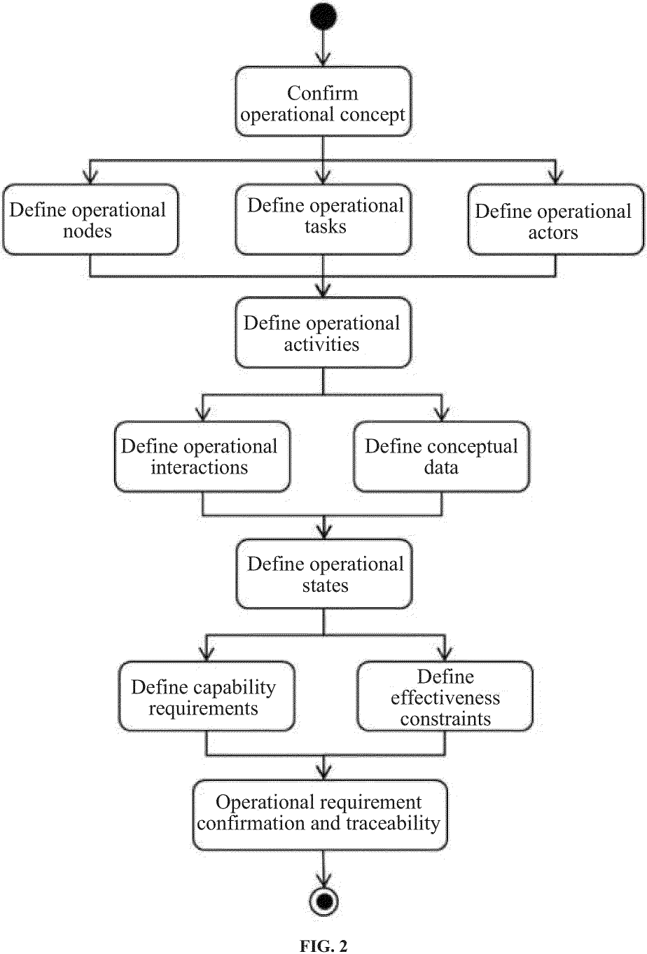

The development process of the UAS from the operational viewpoint is a modeling process meeting the development of the system of systems model of the UAS and defined under the full integration of the functional logical relationship of various views in the operational viewpoint and the syntax and semantic rules of SysML, and mainly includes the following 9 activities as shown in FIG. 2.

(1) From a viewpoint of UAS operation, description of the operational concept provided by a user is analyzed. The operational concept is transformed into itemized operational requirements. An SysML requirement diagram is used for expression.

(2) Relevant operational nodes are identified from the operational requirements, and an SysML block definition diagram is used for expression.

(3) Main operational tasks are identified from the operational requirements, and an SysML use case diagram is used for expression.

(4) Operational activities are defined for each operational task, as well as a control flow and an object flow between the operational activities are defined. These activities are assigned to different swimlanes. An SysML activity diagram is used for expression. Each swimlane is associated with the operational node.

(5) Conceptual data used in the system of systems model is defined by analyzing the object flow in the operational activities, and an SysML block definition diagram is used for expression.

(6) Based on activities (4) and (5), synchronous or asynchronous messages transferred between the operational nodes can be defined, and an SysML sequence diagram is used for expression. This step is optional.

(7) Based on activities (4) and (5), the control flow and object flow between different swimlanes can be transformed into operational ports between the operational nodes. The conceptual data transferred in the operational ports is defined. An SysML internal block diagram is used for expression.

(8) A state that the operational node is capable of maintaining for a long time is analyzed. The state is associated with the operational activities assigned to the operational node in the swimlane. A state transition logic of the operational node is defined. An SysML state machine diagram is used for expression.

(9) An MOE of the operational concept and a KPP of the operational node are defined. A constraint relationship between the MOE and the KPP is established. An SysML parametric diagram is used for expression.

After the interlocking design and modeling activities in step 2, a system of systems description model of the UAS oriented to the operational concept is generated. Through the analysis and execution of the model, the operational requirements are verified and confirmed, and finally the correct operational requirements of the UAS are finally output as input for model development of the UAS.

Step 3: A development process of the UAS from a logical viewpoint is designed. A logical model and geometric model of the UAS itself are developed according to input UAS operational requirements. Simulation of a system model is carried out. Rationality of the system model is verified. System requirements are generated.

The development process of the UAS from the logical viewpoint is a modeling process meeting the model development of the UAS and defined under the full integration of the functional logical relationship of various views in the logical viewpoint and the syntax and semantic rules of SysML. It mainly includes the following 9 activities as shown in FIG. 3.

(1) From a viewpoint of UAS designers, the operational requirements assigned to operational nodes of the UAS are transformed into technical requirements of the UAS, and an SysML requirement diagram is used for expression.

(2) Based on operational activities assigned to the operational nodes of the UAS, the operational activities are decomposed into top-level functions of the UAS, and an SysML use case diagram is used for expression.

(3) Based on the top-level functions of the UAS, system functions are decomposed and analyzed with domain knowledge. The functions are assigned to different swimlanes. An SysML activity diagram is used for expression.

(4) Internal components of the UAS are defined by analyzing the swimlanes in the system activity diagram, and an SysML block definition diagram is used for expression.

(5) Logical data of the system is defined by analyzing a control flow and an object flow between the swimlanes in system activities, and an SysML block definition diagram is used for expression.

(6) Based on activities (4) and (5), synchronous or asynchronous messages transferred between the system elements can be analyzed, and an SysML sequence diagram is used for expression. This step is optional.

(7) Based on activities (4) and (5), the control flow and the object flow between different swimlanes can be transformed into logical ports between system elements. The logical data transferred in the logical ports is defined. An SysML internal block diagram is used for expression.

(8) A state that the system element is capable of maintaining for a long time is defined. The state is associated with the system activities assigned to the system element in the swimlane. A state transition logic of the system element is defined. An SysML state machine diagram is used for expression.

(9) A KPP assigned to the operational nodes of the UAS is transformed into an MOP of the UAS. A constraint relationship between the MOP of the UAS and an MOP of the system element is established. An SysML parametric diagram is used for expression.

After the interlocking design and modeling activities in step 3, a description model of the UAS is generated. Through the analysis and execution of the model, the system requirements are verified and confirmed, and finally the correct system requirements are finally output as input for development of the component model of the UAS.

Step 4: A development process of the UAS from a physical viewpoint is designed. A logical model and mathematical model of components of the UAS are developed according to input UAS requirements. Simulation of a component model is carried out. Rationality of the component model is verified. Component requirements are generated.

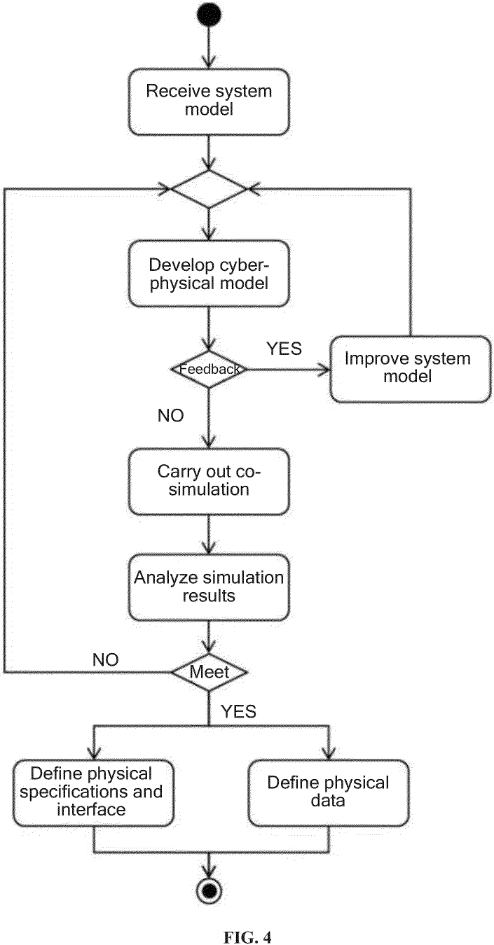

The development process of the UAS from the physical viewpoint is a modeling process meeting the development of the component model of the UAS and defined under the full integration of the functional logical relationship of various views in the physical viewpoint and the syntax and semantic rules of SysML and Modelica. It mainly includes the following 6 activities as shown in FIG. 4.

(1) Mapping rules of SysML and Modelica oriented to the UAS are established, and the system composition and cross-linking relationship in a UAS model are transformed into a cyber-physical model of the UAS.

(2) A mapping relationship between the Modelica-based cyber-physical model of the UAS and an SysML-based system description model is checked so as to ensure the same level, composition, and interface relationship.

(3) A cyber-physical model of the components of the UAS is developed with disciplinary knowledge, and integrated into a rapid prototype of the UAS from the bottom up according to the level, composition, and interface relationship of the UAS.

(4) By using a non-causal Modelica solver, co-simulation of the rapid prototype of the UAS is carried out to verify that the design parameters meet the MOPs of the system elements and the system.

(5) Design parameters verified by simulation are passed down as physical specifications, and instance specification block definition diagrams are used in SysML for description.

(6) A physical interface and physical data involved in the physical specifications are described with the instance specification block definition diagrams in SysML.

After the interlocking design and modeling activities in step 4, the component model of the UAS based on the instance specifications is finally generated.

Step 5: Integration of cross-level spatio-temporal models, logical models, and mathematical models from the operational viewpoint, the logical viewpoint, and the physical viewpoint is carried out, so as to realize multi-domain, multi-dimensional, and multi-disciplinary UAS architecture simulation, and carry out closed-loop verification of the operational requirements, the system requirements, and the component requirements of the UAS. The “realization of cross-domain, multi-dimensional, and multi-disciplinary UAS architecture simulation” refers to the comprehensive integrated verification of lightweight in different fields across time and space, functional and logical, and discrete and continuity, involving different dimensions from one dimension to three dimensions, and integrating various disciplines such as mechanical, electrical, hydraulic, and control disciplines.

While the system of systems description model, system description model, component description model, and cyber-physical model of the UAS are established, it is also necessary to simultaneously develop the spatio-temporal information model and system geometric model of the UAS of the operational concept to express the natural environment and external systems that interact with the UAV.

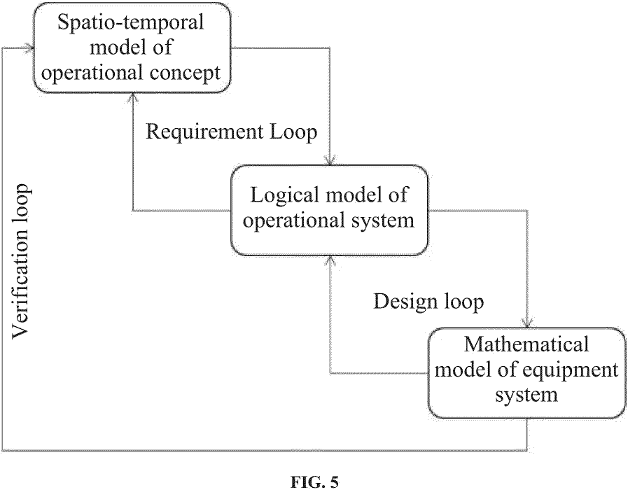

The above models can be divided into spatio-temporal models, logical models, and mathematical models according to their characteristics. By integrating three types of heterogeneous models, the functional logical and mathematical mechanism of the UAS are placed in the operational environment, so as to realize the rapid verification of the UAS architecture oriented to the operational concept, thereby reducing the development risk, shortening the development period, and improving the product quality. The integration principle of the “spatio-temporal-logical-mathematical” models of the UAS architecture is shown in FIG. 5, which involves the integrated development of three interfaces.

(1) A spatio-temporal and logical interface mainly obtains event, signal, position, and distance data from the spatio-temporal model, and triggers execution of operational behaviors in the logical model, and the logical model drives simulation of the spatio-temporal model according to an operational logic and operational rules.

(2) A logical and mathematical interface mainly realizes transformation of structure, data, and interface between the logical model and the mathematical model. The logical model transfers a system architecture and metric constraints to the mathematical model, and the mathematical model feeds back solution results and physical parameters to the logical model.

(3) A mathematical and spatio-temporal interface drives transformation of temporal and spatial information in the spatio-temporal model mainly based on real-time solution results of the mathematical model, thereby generating new events, signals, positions, and distances.

### IMPLEMENTATION EXAMPLES

Next, the implementation steps of the present disclosure will be demonstrated in combination with the set operational concept.

Operational concept: At some point in the future, if a suspicious target is found in a certain area, the command center will direct a novel UAS to carry out reconnaissance and strike tasks through communication satellites. The architecture design of the novel UAS now needs to be carried out using a model-based architecture design method for a UAS.

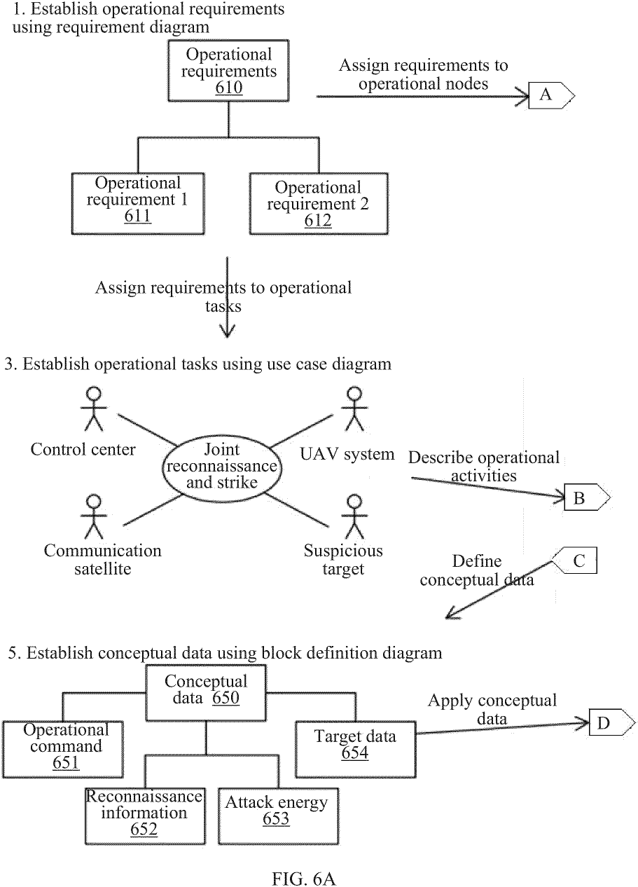

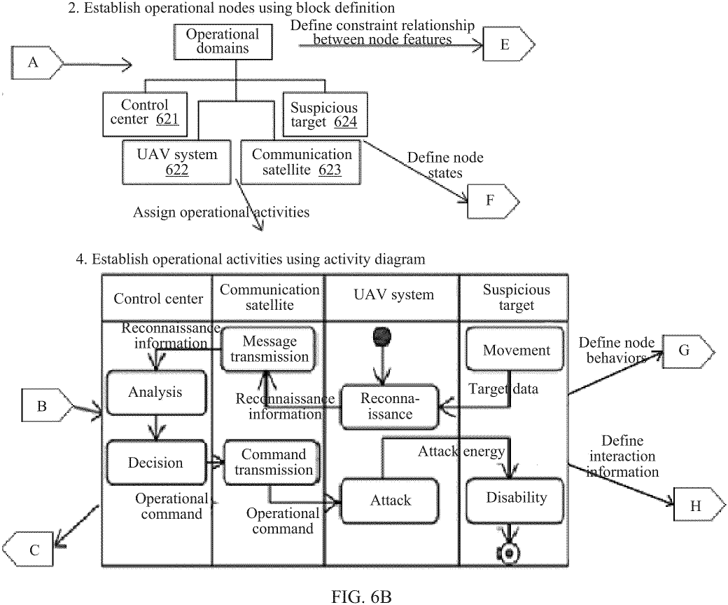

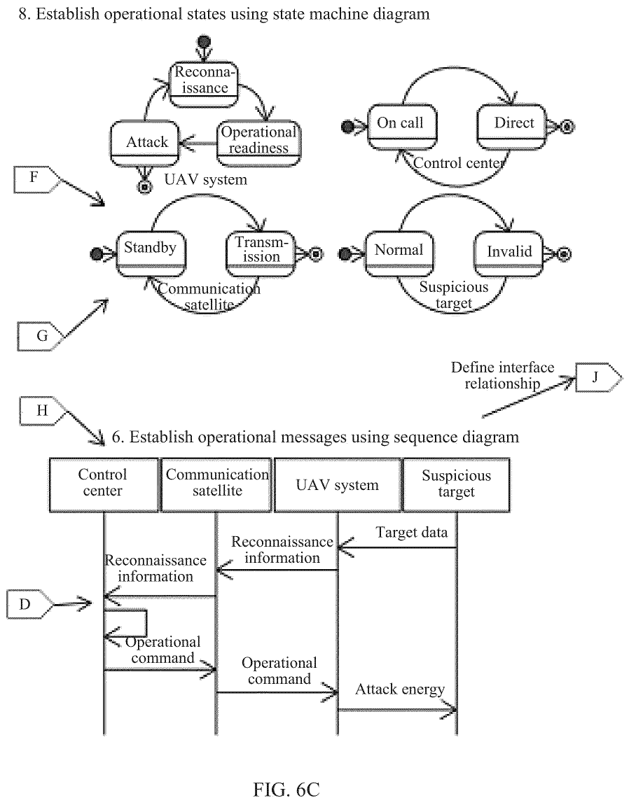

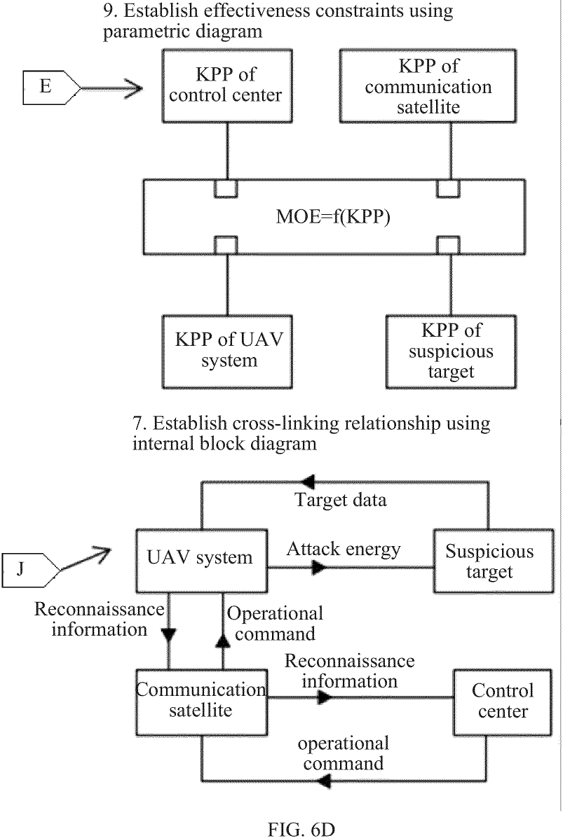

(1) A model of the UAS from an operational viewpoint is developed, as shown in FIGS. 6A-6D. The following steps are explained in order according to the suggested steps in the figures.

Step 1. Operational requirements (610) are established using a requirement diagram: “operational requirement 1 (611)” and “operational requirement 2 (612)” are obtained through analysis of the operational concept.

Step 2. Operational nodes are established using a block definition diagram: through analysis of the operational concept, the involved operational nodes including the command center (621), the UAS (622), the communication satellite (623), and the suspicious targets (624) can be extracted.

Step 3. Operational tasks are established using a use case diagram: through analysis of the operational concept, it can be concluded that the main operational concept is joint reconnaissance and strike, and the above four operational nodes are involved.

Step 4. Operational activities are established using an activity diagram: the operational activities of the joint reconnaissance and strike operational task are established, and expressed with the swimlane diagram, and all the actors in step 3 of the swimlane are designed.

Step 5. Conceptual data (650) is established using a block definition diagram: through analysis of the swimlane diagram established in step 4, the conceptual data transferred between operational activities can be obtained, including operational instructions (651), reconnaissance information (652), attack energy (653), and target data (654).

Step 6. Operational messages are established using a sequence diagram: another presentation of the behavior and data identified in steps 4 and 5. This step is optional.

Step 7. A cross-linking relationship is established using an internal block diagram: through analysis of the models in steps 4 and 5, the data transferred between the command center, the UAS, the communication satellite, and the suspicious target can be obtained.

Step 8. Operational states are established using a state machine diagram: the operational states of the command center, UAS, communication satellite, and suspicious target are analyzed, their respective state machines and conditions for state transition are established, and the operational activities assigned to each node in step 4 are integrated.

Step 9. Effectiveness constraints are established using a parametric diagram: the MOE of the entire operational concept, as well as the KPPs of the command center, UAS, communication satellite, and suspicious target are defined, and a mathematical equation between the MOE and the KPP is established.

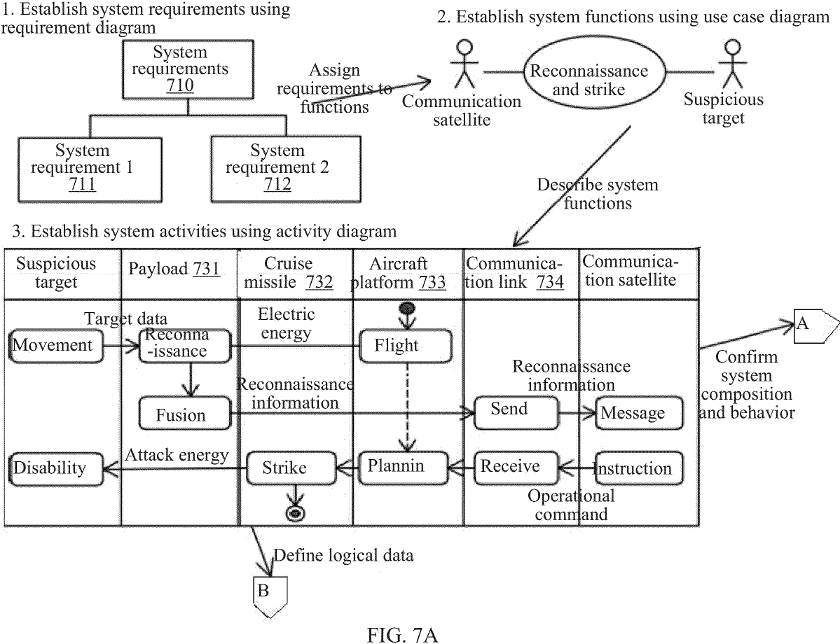

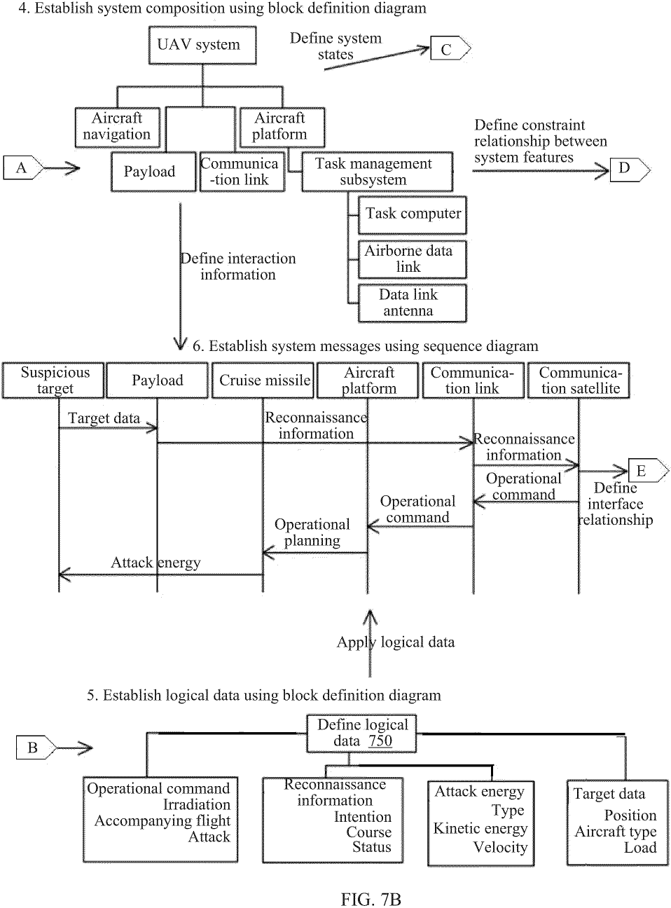

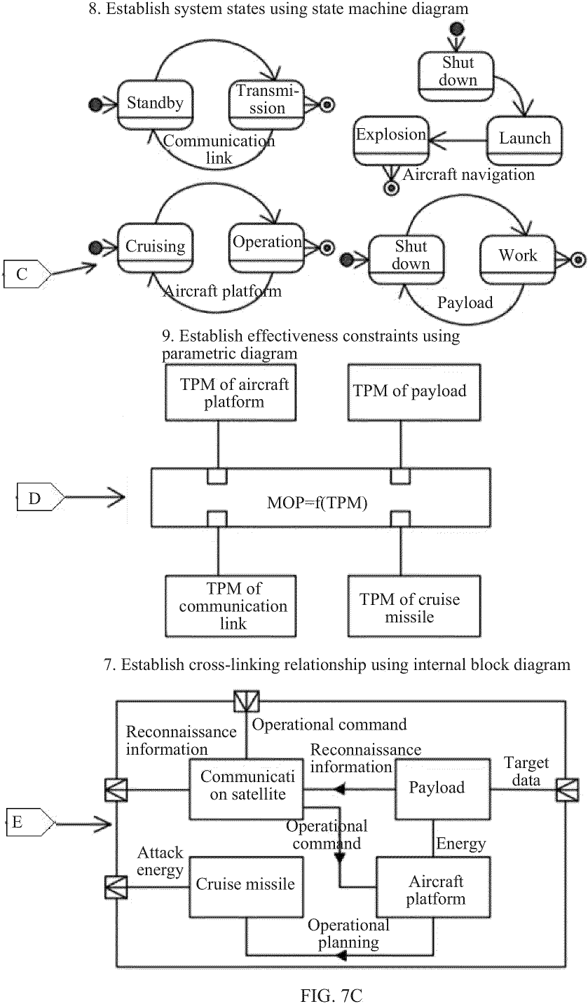

(2) A model of the UAS from a logical viewpoint is developed, as shown in FIGS. 7A-7C. The following steps are explained in order according to the suggested steps in the figures.

Step 1. System requirements (710) are established using a requirement diagram: “System Requirement 1 (711)” and “System Requirement 2 (712)” are obtained by analyzing the operational requirements assigned to the UAS.

Step 2. System functions are established using a use case diagram: through the analysis of the operational concept, it can be concluded that the main system function is reconnaissance and strike, and the system actors are communication satellites and suspicious targets.

Step 3. System activities are established using an activity diagram: the system activities of the reconnaissance and strike system functions are established, and the system element composition can be obtained by dividing the system activities into swimlanes, including payloads (731), cruise missiles (732), aircraft platforms (733), communication links (734), and interactions with communication satellites and suspicious targets.

Step 4. System composition is established using a block definition diagram: the system composition can be obtained by analyzing the swimlane of the system activities. Steps 3 and 4 can be recursively performed, thereby identifying the lowest system elements.

Step 5. Logical data (750) is established using a block definition diagram: through analysis of the swimlane diagram in step 3, it can be concluded that the logical data transferred between the system elements is a further refinement of conceptual data such as operational instructions, reconnaissance information, attack energy, and target data.

Step 6. System messages are established using a sequence diagram: another presentation of the behavior and data identified in steps 4 and 5. This step is optional.

Step 7. A cross-linking relationship is established using an internal block diagram: through analysis of the models in steps 4 and 5, the data transferred between the payload, the cruise missile, the aircraft platform, and the communication link, and the data interacting with the communication satellite and the suspicious target can be obtained.

Step 8. System states are established using a state machine diagram: the system states of the payload, the cruise missile, the aircraft platform, and the communication link are analyzed, their respective state machines and conditions for state transition are established, and the system activities assigned to each system element in step 3 are integrated.

Step 9. Effectiveness constraints are established using a parametric diagram: the KPP of the UAS is transformed into the MOP of the UAS, and the MOPs of the payload, the cruise missile, the aircraft platform, and the communication link are defined based on the decomposition of the MOP of the system. A mathematical equation between the MOPs is established.

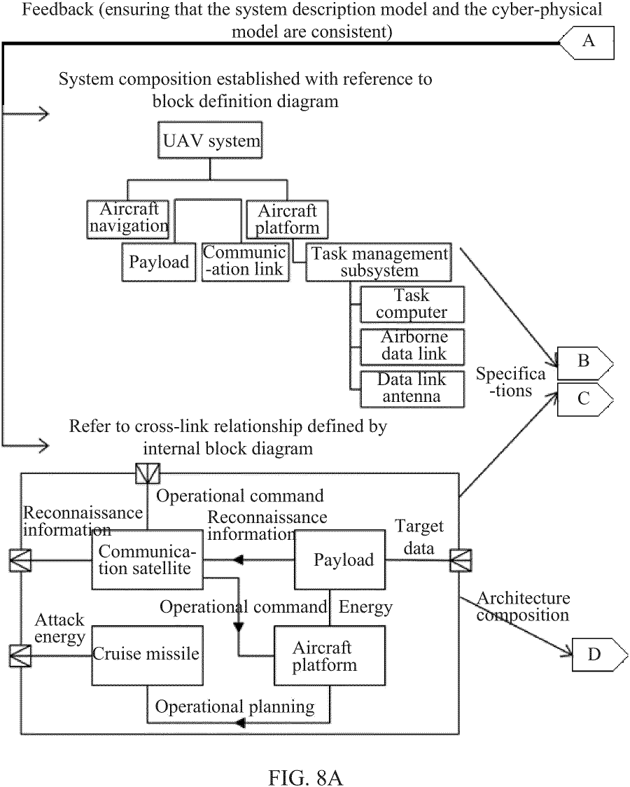

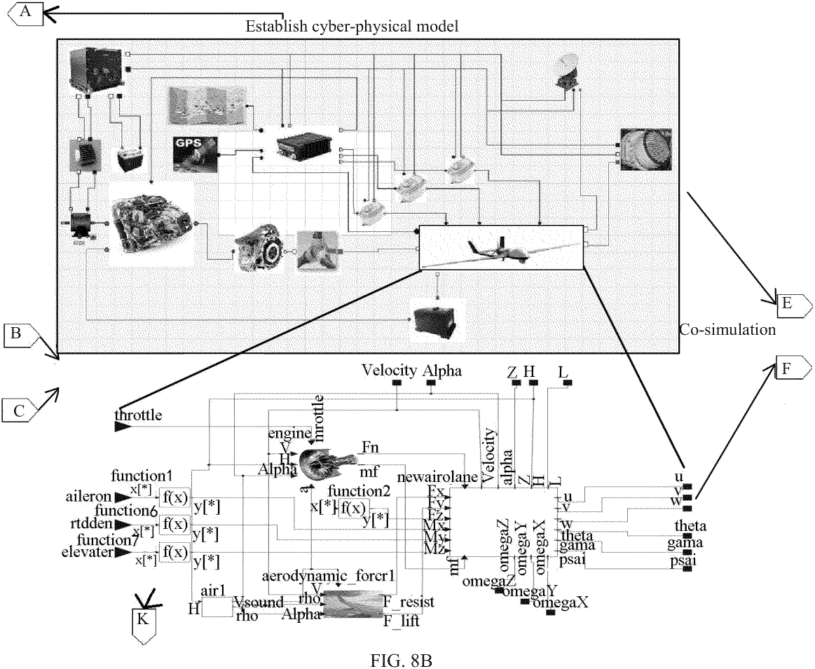

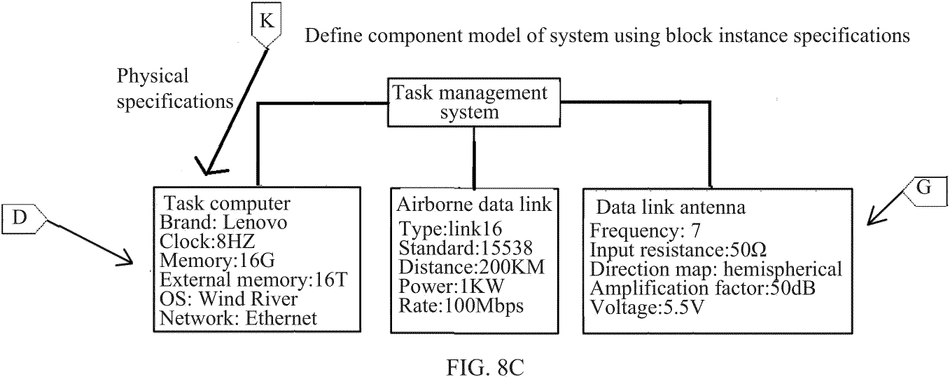

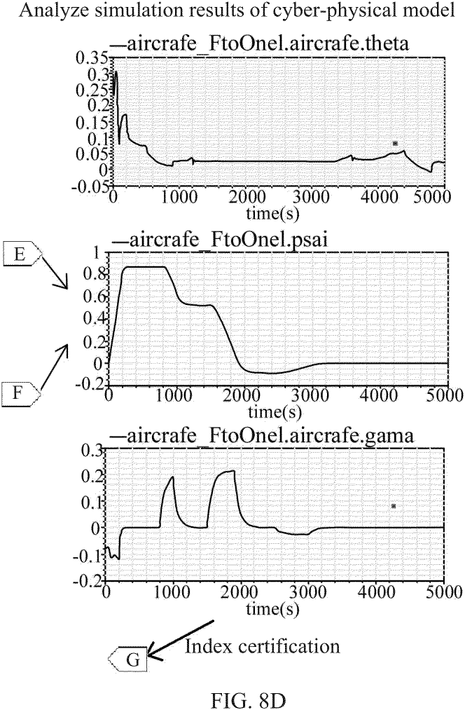

(3) A model of the UAS from a physical viewpoint is developed, as shown in FIGS. 8A-8D.

Based on the description model of the UAS from the logical viewpoint, the cyber-physical model of the UAS is generated. Generally, the description model and cyber-physical model of the UAS have the same hierarchical structure and interface relationship.

Step 1. Based on mapping rules of SysML and Modelica of the UAS, the SysML description model of the UAS is transformed into the Modelica-based cyber-physical model of the UAS.

Step 2. The Modelica-based cyber-physical model and the SysML-based system description model of the UAS are checked so as to ensure that the models have the same level, composition, and interface mapping relationship.

Step 3. Components of the UAS are designed with disciplinary knowledge. A cyber-physical model of the components is developed, and integrated into a rapid prototype of the UAS from the bottom up according to the level, composition, and interface relationship of the UAS.

Step 4. Co-simulation of the rapid prototype of the UAS is carried out to verify that the design parameters of the components of the UAS meet the MOPs of the system elements and the system.

Step 5. The instance specification block definition diagram in SysML is used to record the design parameters verified by the simulation, and pass them down as the physical specifications of the components of the UAS.

Step 6. The instance specification block definition diagram in SysML is used to record the physical interface and physical data involved in the physical specifications.

What is claimed is:

1. A model-based architecture design method for an unmanned aerial vehicle system (UAS), comprising the following specific steps:
step 1: establishing an architecture development framework of the UAS, comprising: defining viewpoints of concern in a UAS architecture design process and views to be developed in each viewpoint;
step 2: designing a development process of the UAS from an operational viewpoint, developing a logical model and spatio-temporal model of UAS operation according to an input UAS operational concept, carrying out simulation of a system of systems model, verifying rationality of the system of systems model, and generating operational requirements;
step 3: designing a development process of the UAS from a logical viewpoint, developing a logical model and geometric model of the UAS itself according to input UAS operational requirements, carrying out simulation of a system model, verifying rationality of the system model, and generating system requirements;
step 4: designing a development process of the UAS from a physical viewpoint, developing a logical model and mathematical model of components of the UAS according to input UAS requirements, carrying out simulation of a component model, verifying rationality of the component model, and generating component requirements; and
step 5: carrying out integration of cross-level spatio-temporal models, logical models, and mathematical models from the operational viewpoint, the logical viewpoint, and the physical viewpoint, so as to realize multi-domain, multi-dimensional, and multi-disciplinary UAS architecture simulation, and carry out closed-loop verification of the operational requirements, the system requirements, and the component requirements of the UAS to obtain component parameters;
step 6: constructing the UAS based on the obtained component parameters.

2. The model-based architecture design method for the UAS according to claim 1, wherein in step 1, 3 viewpoints and 26 views are defined; and the 3 viewpoints comprise the operational viewpoint, the logical viewpoint, and the physical viewpoint; the operational viewpoint and the logical viewpoint are divided into 5 categories and 22 views according to requirements, structures, behaviors, constraints, data, and simulation, and the physical viewpoint is divided into 3 categories and 4 views according to product, data, and simulation; and requirement, structure, behavior, constraint, and data-type models in the operational and logical viewpoints, and product and data-type models in the physical viewpoint belong to logical models, simulation models in the three viewpoints belong to mathematical models, and due to time and space characteristics, the spatio-temporal information model and the system geometric model are subsumed to spatio-temporal models;
the views contained in the above operational viewpoint are: operational requirements, operational requirement traceability, operational nodes, operational interactions, operational actors, operational tasks, operational activities, operational states, conceptual data, effectiveness constraints, and spatio-temporal information models;
the views contained in the logical viewpoint are: system requirements, system requirement traceability, system composition, system interactions, system actors, system functions, system activities, system states, logical data, performance constraints, and system geometric models; and the views contained in the physical viewpoint are physical specifications, physical interfaces, physical data, and cyber-physical models.

3. The model-based architecture design method for the UAS according to claim 1, wherein in step 2, the development process of the UAS from the operational viewpoint comprises the following activities:
(1) from a viewpoint of UAS operation, analyzing description of the operational concept provided by a user, transforming the operational concept into itemized operational requirements, and using an SysML requirement diagram for expression;
(2) identifying relevant operational nodes from the operational requirements, and using an SysML block definition diagram for expression;
(3) identifying main operational tasks from the operational requirements, and using an SysML use case diagram for expression;
(4) defining operational activities for each operational task, as well as a control flow and an object flow between the operational activities, and assigning these activities to different swimlanes, using an SysML activity diagram for expression, wherein each swimlane is associated with the operational node;
(5) defining conceptual data used in the system of systems model by analyzing the object flow in the operational activities, and using an SysML block definition diagram for expression;
(6) based on activities (4) and (5), transforming the control flow and object flow between different swimlanes into operation ports between the operational nodes, defining the conceptual data transferred in the operation ports, and using an SysML internal block diagram for expression;
(7) analyzing a state that the operational node is capable of maintaining for a long time, associating the state with the operational activities assigned to the operational node in the swimlane, defining a state transition logic of the operational node, and using an SysML state machine diagram for expression; and
(8) defining a measure of effectiveness (MOE) of the operational concept and a key performance parameter (KPP) of the operational node, establishing a constraint relationship between the MOE and the KPP, and using an SysML parametric diagram for expression.

4. The model-based architecture design method for the UAS according to claim 3, wherein the development process of the UAS from the operational viewpoint further comprises the following activities: based on activities (4) and (5), defining synchronous or asynchronous messages transferred between the operational nodes, and using an SysML sequence diagram for expression.

5. The model-based architecture design method for the UAS according to claim 1, wherein in step 3, the development process of the UAS from the logical viewpoint comprises the following activities:
(1) from a viewpoint of UAS designers, transforming the operational requirements assigned to operational nodes of the UAS into technical requirements of the UAS, and using an SysML requirement diagram for expression;
(2) based on operational activities assigned to the operational nodes of the UAS, decomposing the operational activities into top-level functions of the UAS, and using an SysML use case diagram for expression;
(3) based on the top-level functions of the UAS, decomposing and analyzing system functions with domain knowledge, assigning the functions to different swimlanes, and using an SysML activity diagram for expression;
(4) defining internal components of the UAS by analyzing the swimlanes in the system activity diagram, and using an SysML block definition diagram for expression;
(5) defining logical data of the system by analyzing a control flow and an object flow between the swimlanes in system activities, and using an SysML block definition diagram for expression;
(6) based on activities (4) and (5), transforming the control flow and the object flow between different swimlanes into logical ports between system elements, defining the logical data transferred in the logical ports, and using an SysML internal block diagram for expression;
(7) analyzing a state that the system element is capable of maintaining for a long time, associating the state with the system activities assigned to the system element in the swimlane, defining a state transition logic of the system element, and using an SysML state machine diagram for expression; and
(8) transforming a KPP assigned to the operational nodes of the UAS into a measure of performance (MOP) of the UAS, establishing a constraint relationship between the MOP of the UAS and an MOP of the system element, and using an SysML parametric diagram for expression.

6. The model-based architecture design method for the UAS according to claim 5, wherein the development process of the UAS from the logical viewpoint further comprises the following activities: based on activities (4) and (5), defining synchronous or asynchronous messages transferred between the operational nodes, and using an SysML sequence diagram for expression.

7. The model-based architecture design method for the UAS according to claim 1, wherein in step 4, the development process of the UAS from the physical viewpoint comprises the following activities:
(1) based on transformation standards of SysML and Modelica, transforming a hierarchical structure and a cross-linking relationship in a UAS model into a cyber-physical model of the UAS;
(2) ensuring that the Modelica-based cyber-physical model of the UAS and an SysML-based system description model have a same level, composition, and interface relationship, and developing a cyber-physical model of the components of the UAS with disciplinary knowledge;
(3) based on an idea of componentized design, integrating a UAS component model containing multiple disciplines into a rapid prototype of the UAS from the bottom up according to the system level, composition, and interface relationship;
(4) by using a non-causal Modelica solver, carrying out multi-disciplinary co-simulation to verify feasibility of MOPs of the system and a system element;
(5) passing down design parameters verified by simulation as physical specifications, and using instance specification block definition diagrams in SysML for description; and
(6) describing a physical interface and physical data involved in the physical specifications with the instance specification block definition diagrams in SysML.

8. The model-based architecture design method for the UAS according to claim 1, wherein in step 5, integration of cross-level spatio-temporal models, logical models, and mathematical models from the operational viewpoint, the logical viewpoint, and the physical viewpoint is carried out, and the three interfaces involved for integrated development comprises:
(1) a spatio-temporal-logical interface: the spatio-temporal-logical interface mainly obtains event, signal, position, and distance data from the spatio-temporal model, and triggers execution of operational behaviors in the logical model, and the logical model drives simulation of the spatio-temporal model according to an operational logic and operational rules;
(2) a logical-mathematical interface: the logical-mathematical interface mainly realizes transformation of structure, data, and interface between the logical model and the mathematical model, the logical model transfers a system architecture and metric constraints to the mathematical model, and the mathematical model feeds back solution results and physical parameters to the logical model; and
(3) a mathematical-spatio-temporal interface: the mathematical-spatio-temporal interface drives transformation of temporal and spatial information in the spatio-temporal model mainly based on real-time solution results of the mathematical model, thereby generating new events, signals, positions, and distances.
